(19) United States
(12) Patent Application Publication
(10) Pub. No.: US 2015/0033573 A1
(43) Pub. Date: Feb. 5, 2015

(54) DEHYDRATOR

(71) Applicant: Kwan Heum Sim, (US)

(72) Inventor: Kwan Heum Sim, Gyeonggi-do (KR)

(21) Appl. No.: 14/354,218

(22) PCT Filed: Oct. 29, 2012
(86) PCT No.: PCT/KR2012/008931

§ 371 Date: Apr. 25, 2014

(30) Foreign Application Priority Data
Oct. 27, 2011 (KR) 10-2011-0110529

(51) Int. Cl. F26B 25/16

(52) U.S. Cl. CPC F26B 25/16
USPC 34/108

(57) ABSTRACT

The present invention relates to a dehydrator, and more particularly, to a technology for achieving improved dehydration efficiency as compared to conventional technologies while maintaining a volume, dehydration time, and rotational speed that are nearly the same as those of conventional technologies. To this end, the dehydrator of the present invention comprises: a main body having an installation space therein; a pipe for supplying items to be dehydrated, which is located within the installation space of the main body, one side of which has an inlet hole for items to be dehydrated that is connected to the outside, inside which a supply space connected to the inlet hole for items to be dehydrated is disposed, and the other side of which has an outlet hole connected to the supply space; a dehydration tub, which is rotatably arranged, which surrounds the pipe for supplying items to be dehydrated in the installation space, inside which a dehydration space connected to the outlet hole is arranged, the circumferential surface of which has a dehydration hole for interconnecting the dehydration space and the installation space, and one side of which has a discharge port for connecting the dehydration space to the outside; a first driving unit connected to the dehydration tub so as to rotate the dehydration tub; and a discharge guide unit located within the dehydration space so as to move the item to be dehydrated placed in the dehydration space toward the discharge port.

### CROSS-REFERENCE TO RELATED APPLICATIONS

This application is a National phase of PCT patent Application No. PCT/KR2012/008931 having International filing date of Oct. 29, 2012 which claims the benefit of priority of Korean Patent Application No. 10-2011-0110529 filed on Oct. 27, 2011. The contents of the above applications are all incorporated by reference as if fully set forth herein in their entirety.

### TECHNICAL FIELD

The present invention relates to a dehydrator, and more particularly, to a technology for achieving improved dehydration efficiency as compared to conventional technologies, in which items to be dehydrated are newly input during a dehydrating process and thus input and dehydration of the items to be dehydrated may be continuously performed.

### BACKGROUND ART

Generally, sludge generated during a water treatment process or all of by-products generated in a state of containing water in other industrial fields are wasted after a dehydration process which minimizes water during the treatment process.

In this case, an existing used dehydrator is generally divided into a compression type dehydrating method and a rotatory type dehydrating method.

In the existing dehydrators, the items to be dehydrated may not be additionally supplied while the dehydration is performed after inputting the items to be dehydrated in a dehydration tub regardless of a dehydration method, and a process of newly inputting the items to be dehydrated after the dehydration is completed and the items to be dehydrated are removed is repeated.

That is, the dehydrating process and the process of inputting the items to be dehydrated are clearly separately performed.

As a result, the existing dehydrators have nothing to have space consumption, a manufacturing load problem, and an energy loss problem because a scale of the dehydrator is inevitably manufactured to be large to increase a treatment capacity or a rotation speed of the dehydration tub is increased in order to increase a dehydration amount.

### DETAILED DESCRIPTION OF THE INVENTION

### Technical Problem

The present invention has been made in an effort to provides

a dehydrator having an advantage of obtaining high treatment efficiency even as a small dehydrator while input of new items to be dehydrated may be continuously performed during a dehydration process.

### Technical Solution

An exemplary embodiment of the present invention provides a dehydrator, including:

a main body having an installation space therein; a pipe for supplying items to be dehydrated, which is located within the installation space of the main body, one side of which has an inlet hole for items to be dehydrated that is connected to the outside, inside which a supply space connected to the inlet hole for items to be dehydrated is disposed, and the other side of which has an outlet hole connected to the supply space; a dehydration tub, which is rotatably arranged, which surrounds the pipe for supplying items to be dehydrated in the installation space, inside which a dehydration space connected to the outlet hole is arranged, the circumferential surface of which has a dehydration hole for interconnecting the dehydration space and the installation space, and one side of which has a discharge port for connecting the dehydration space to the outside; a first driving unit connected to the dehydration tub so as to rotate the dehydration tub; and a discharge guide unit located within the dehydration space so as to move the item to be dehydrated placed in the dehydration space toward the discharge port.

The dehydrator may further include a second driving unit connected to the pipe for supplying items to be dehydrated to rotate the pipe for supplying items to be dehydrated, in which the discharge guide unit may have a screw wing form to have a protruding form on the circumferential surface of the pipe for supplying items to be dehydrated along the length direction.

Further, the dehydration tub may include a first hydration pipe covering the pipe for supplying items to be dehydrated and a second dehydration pipe covering the first dehydration pipe.

In addition, the dehydrator may further include a supply guide unit positioned in the supply space and moving the items to be dehydrated inserted through the inlet hole toward the outlet hole.

Further, the dehydrator may further include: a sorting case positioned at one side of the dehydration tub, having a discharge space connected with the discharge port, and having a sorting hole connecting the discharge space and the outside at one side; and a sorting guide unit rotatably installed in the discharge space and moving the items to be dehydrated discharged through the discharge hole toward the sorting hole.

In addition, the pipe for supplying items to be dehydrated may pass through the sorting space, the discharge hole may be formed around a passing point of the pipe for supplying items to be dehydrated of the dehydration tub, and the sorting guide unit may be radially installed toward the outside based on the pipe for supplying items to be dehydrated to have a rotary wing form.

Further, the dehydrator may further include a water discharge port formed at one side of the dehydration tub to connect the installation space and the outside.

### Advantageous Effects

According to the exemplary embodiments of the present invention,

the pipe for supplying items to be dehydrated is inserted into the dehydrated tub and thus the dehydration space and the supply space of the items to be dehydrated are separately formed in the dehydration tub, and while the dehydration of the items to be dehydrated is performed, the items to be dehydrated are automatically discharged by the discharge guide unit.

As a result, unlike the related art, during the dehydration process, since the items to be dehydrated may be continuously supplied, there is an advantage of having a significantly high dehydration amount even by a small-sized dehydrator.

### BRIEF DESCRIPTION OF DRAWINGS

FIG. 1 is an overall cross-sectional view.

FIG. 2 is a cross-sectional view of line A-A′ illustrating a structure of a sorting case and a sorting guide unit.

FIG. 3 is a cross-sectional view of line B-B′ illustrating a structure of a pipe for supplying items to be dehydrated, a dehydration tub, and a main body, and a discharge path of water.

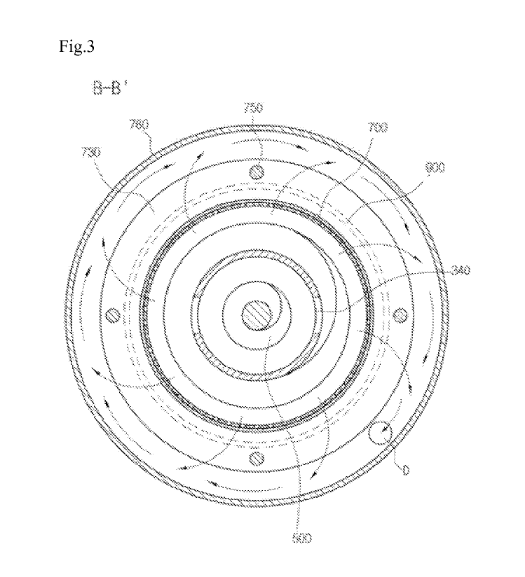

FIG. 4 is a cross-sectional view illustrating a state where items to be dehydrated are initially input to the pipe for supplying the items to be dehydrated.

FIG. 5 is an overall cross-sectional view illustrating a form in which water and solids are separated to each other to be discharged through a dehydration process after the items to be dehydrated are supplied to the dehydration tub through the pipe for supplying the items to be dehydrated.

FIG. 6 is an overall cross-sectional view illustrating a case where a separate cleaning unit is further installed.

### BEST MODE

Hereinafter, detailed configurations and effects of the present invention will be described with reference to exemplary embodiments illustrated in the drawings.

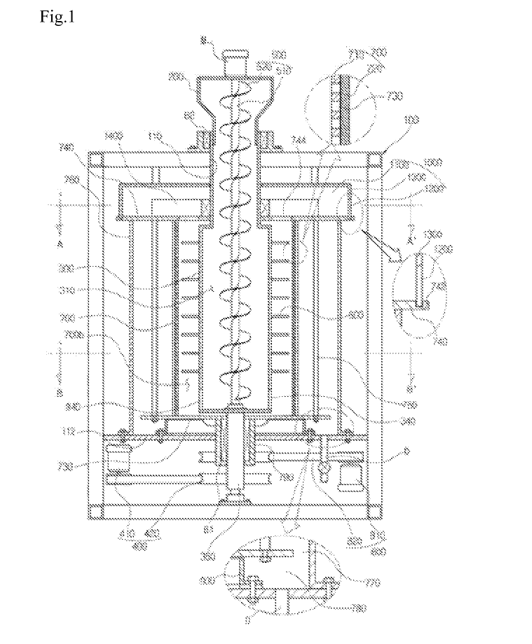

As illustrated in FIG. 1, a dehydrator of the present invention is largely configured by including a main body 100, a pipe for supplying items to be dehydrated 300, a first driving unit 400, a supply guide unit 500, a dehydration tub 700, and a second driving unit 800.

First, the main body 100 serves as an overall frame of the present invention and is configured by a connection structure between frames such as a plurality of H beams.

In this case, a partition 112 for serving as a support plate of other constituent elements to be described below is formed in the main body 100.

In addition, a coupling hole 110 in which an inlet hopper 200 to be described below is installed is formed at an upper center of the main body 100.

Referentially, the structure of the main body 100 is not limited to the configuration in the drawing, but any structure which may serve to support each constituent element to be described below may be modified.

The pipe for supplying items to be dehydrated 300 is installed in the main body 100.

The pipe 300 for supplying items to be dehydrated serves as a supply path of the items to be dehydrated and an operation source of a discharge guide unit to be described below, in which a lower portion is entirely blocked and has a hollow pipe with a supply space 310 therein, a first driving shaft 350 connected to the lower portion passes through the central bottom of the partition 112, and an upper portion is installed to be inserted into the coupling hole 110 of the main body 100.

In this case, a first bearing B1 is installed between the first driving shaft 350 and the partition 112, and a second bearing B2 is installed between the upper portion of the pipe for supplying items to be dehydrated and the coupling hole 112, and as a result, the pipe 300 for supplying items to be dehydrated is rotatably installed on the main body 100.

In addition, outlet holes 340 to which the items to be dehydrated in the supply space 310 are discharged to the dehydration space of the dehydration tub to be described below are formed at both lower sides of the pipe 300 for supplying items to be dehydrated.

The first driving unit 400 is connected to the pipe 300 for supplying items to be dehydrated which is installed above.

The first driving unit 400 serves as a driving source required for rotation of the pipe 300 for supplying items to be dehydrated, and is configured by a first driving motor 410 and a first power transferring unit 420 again.

The first driving motor 410 is positioned in a space below the partition of the main body 100, and the first power transferring unit 420 is generally configured by a belt, a sprocket, and a gear structure to be connected with the first driving shaft 350 of the pipe 300 for supplying items to be dehydrated.

As a result, driving force of the first driving motor 410 is transferred to the first driving shaft 350 through the first power transferring unit 420 to have structure in which the pipe 300 for supplying items to be dehydrated is rotated.

The insertion hopper 200 is installed in the pipe 300 for supplying items to be dehydrated which is installed above.

The insertion hopper 200 is a portion for supplying external items 1 to be dehydrated to the pipe 300 for supplying items to be dehydrated, and configured by a general hopper structure, and the lower portion is inserted into a supply hole of the pipe 300 for supplying items to be dehydrated while being positioned on the upper surface of the main body 100.

The items 1 to be dehydrated supplied through the insertion hopper 200 by the structure directly flow into the pipe 300 for supplying items to be dehydrated.

The supply guide unit 500 is installed in the pipe 300 for supplying items to be dehydrated while installed up to the insertion hopper 200.

The supply guide unit 500 moves the items to be dehydrated which are supplied into the insertion hopper 200 and the pipe 300 for supplying items to be dehydrated to the outlet hole 340 to be smoothly supplied to the dehydration tub 700 to be described below.

The supply guide unit 500 has a general stirring screw structure, that is, a structure in which a screw wing 510 is formed in a spiral shape in a length direction of the rotation shaft 520.

The supply guide unit 500 is entirely inserted into the pipe 300 for supplying items to be dehydrated through the insertion hopper 200.

In this case, in the supply guide unit 500, a lower section of a middle point is inserted into the pipe 300 for supplying items to be dehydrated in the length direction, and an upper section thereof is positioned in the insertion hopper 200.

In this state, the upper end of the supply guide unit 500 is connected with a motor M of the upper surface of the insertion hopper, and the lower end is rotatably connected to a bottom center of the pipe 300 for supplying items to be dehydrated.

In this case, the lower portion of the supply guide unit 500 and the bottom surface of the pipe 300 for supplying items to be dehydrated are connected to each other through a bearing, and the pipe 300 for supplying items to be dehydrated and the supply guide unit 500 are independently rotated.

In this state, the dehydration tub 700 is installed in the main body 100.

The dehydration tub 700 is a portion in which dehydration of the items to be dehydrated discharged through the pipe 300 for supplying items to be dehydrated is substantially performed, and configured by a first dehydration pipe 710 and a second dehydration pipe 720.

The first dehydration pipe 710 serves to primarily filter out water and dehydrated solids during the dehydration process, and has a hollow-pipe shape in which an inner diameter is larger than an external diameter of the pipe 300 for supplying items to be dehydrated and is installed to cover the pipe 300 for supplying items to be dehydrated.

That is, the pipe 300 for supplying items to be dehydrated is installed to be inserted into the first dehydration pipe 710.

The second dehydration pipe 720 may be entirely formed in a mesh structure or formed in a structure in which minute holes are formed on a metal plate.

In addition, the second dehydration pipe 720 serves to secondarily separate the water and the solids passing through the first dehydration pipe 710, and entirely has a hollow-pipe shape and is installed to cover the first dehydration pipe 710.

The second dehydration pipe 720 is entirely formed in a filter shape such as a non-woven fabric to filter out dehydrated solids having minute sizes, and manufactured to have pores through only the water may pass.

In this case, the second dehydration pipe 720 is manufactured so that the inner diameter of the second dehydration pipe 720 and the outer diameter of the first dehydration pipe 710 are substantially the same as each other to have a structure in which the inner surface of the second dehydration pipe 720 contacts and covers the outer surface of the first dehydration pipe 710, and has a structure with a plurality of dehydration holes 700a due to the holes of the first dehydration pipe 710 and the minute pores of the second dehydration pipe 720 on a circumferential surface.

For reference, the dehydration tub 700 may be formed by not only a double-pipe structure of the first dehydration pipe and the second dehydration pipe 720 but also only one of the two pipes in any structure in which the water and foreign substances may be smoothly separated.

The dehydrated tub formed by the double pipe structure of the first dehydration pipe 710 and the second dehydration pipe 720 has a structure in which a dehydration space 700b is formed therein due to a difference in diameter from the pipe 300 for supplying items to be dehydrated, and the supplying items to be dehydrated is inserted into the dehydration space 700b.

A bottom plate 730 of the dehydration tub 700 is manufactured to have a larger diameter than the diameter of the dehydration tub 700 to have a fringe form.

In addition, an upper plate 740 of the dehydration tub 700 has a flange form with a slightly larger diameter than the bottom plate 730, a slide rail 742 for coupling with a sorting case 1300 to be described below is formed at an upper edge of the upper plate 740 to have a circular form along an edge circumference.

Further, a separate support rod 750 is installed between the upper plate 740 and the bottom plate 730, and the upper plate 740 and the bottom plate 730 are connected to each other through the support rod 750.

In this case, the upper portion of the pipe 300 for supplying items to be dehydrated passes through the center of the upper plate 740, and a discharge hole 744 is formed in a ring shape around the passing point of the pipe 300 for supplying items to be dehydrated.

Further, a second driving shaft 790 protrudes from the lower center of the bottom plat 730 of the dehydration tub to rotatably pass through the partition of the main body 100. In this case, a third bearing B-3 is installed at the passing point of the second driving shaft 790 in the partition to guide smooth rotation of the second driving shaft 790.

In this case, the second driving shaft 790 has a hollow-pipe form to be installed to cover the first driving shaft 350 of the pipe 300 for supplying items to be dehydrated.

Accordingly, the first driving shaft 350 and the second driving shaft 790 are separately rotatable. That is, the pipe 300 for supplying items to be dehydrated and the dehydration tub 700 have a separately rotatable structure.

A second driving unit 800 is connected to the dehydration tub 700.

The second driving unit 800 serves as a driving source required for rotation of the dehydration tub 700, and is configured by a second driving motor 810 and a second power transferring unit 820 again.

The second driving motor 810 is positioned in a space below the partition of the main body 100, and the second power transferring unit 820 is generally configured by a belt, a sprocket, and a gear structure to be connected with the second driving shaft 790 of the dehydration tub 700 like the first power transferring unit.

As a result, the driving force of the second driving motor 810 is transferred to the second driving shaft 790 through the second power transferring unit 820 to rotate the bottom plate 730, and accordingly, the first and second dehydration pipes 710 and 720 and the upper plate 740 are simultaneously rotated.

In addition, the case unit 760 serves to collect the water discharged through the dehydration tub 720 and case the entire dehydration tub, and entirely has a hollow pipe form, the lower portion is seated and fixed on the partition of the main body 100 while covering up to the bottom plate of the dehydration tub, and the upper end is installed to be minutely separated from the lower surface of the upper plate 740 of the dehydration tub.

In this case, as the inner diameter of the case unit 760 is formed to be larger than the bottom plate of the dehydration tub, a drain gap 770 is formed between an inner wall of the case unit 760 and an edge of the bottom plate 730 of the dehydration tub, and a drain space 780 is formed between the inner wall of the case unit 760 and an outer wall of the second dehydration pipe.

In this state, a drain pipe D for discharging the dehydrated water to the outside is installed at a point below the drain gap 770 of the partition 112 of the main body 100.

In addition, a separate drain guide piece 900 is formed between the bottom plate 730 of the dehydration tub 700 and the partition of the main body 100, and installed to cover the second driving shaft 790 of the dehydration tub in a circular ring form.

The water separated from the upper surface of the partition through the drain gap 770 does not move toward the second driving shaft 790 by the drain guide piece 900, but is positioned between the case unit and the drain guide piece to be discharged through the drain pipe D.

A sorting unit 1000 for sorting the dehydrated solids outside is formed on the upper surface of the upper plate 740 of the installed dehydration tub 700.

The sorting unit has a structure, in which a sorting case 1300 where a sorting space 1100 is formed therein, and a sorting hole 1200 connecting the sorting space 1100 and the outside is formed is seated and installed.

In this case, while the outside of the sorting case 1300 is connected with the main body 100 and fixed, a lower edge is inserted into the slide rail 742 formed on the upper plate of the dehydration tub 700 to be maintained in the fixed state without rotating together when the dehydration tub 700 rotates.

The sorting guide unit 1400 is further installed on the installed sorting case 1300.

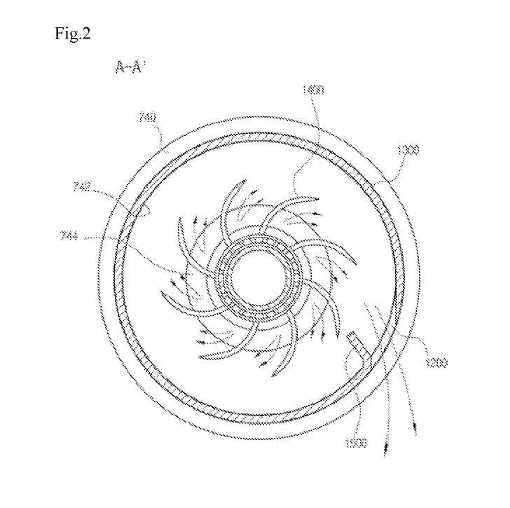

The sorting guide unit 1400 serves to guide movement to the sorting hole 780 after discharging the items to be dehydrated to the sorting space through the discharge hole 744 of the dehydration tub 700, entirely has an impeller form like FIG. 2, and radially disposed on a circumferential surface of the point passing through the upper plate of the dehydration tub 700 of the pipe 300 for supplying items to be dehydrated.

Accordingly, during rotation of the pipe 300 for supplying items to be dehydrated, the sorting guide unit 1400 rotates together, and in this process, the items to be dehydrated discharged through the discharge hole 744 is guided toward the sorting hole 1200 by rotation force of the sorting guide unit 1400.

In this case, a guide piece 1500 is formed in the sorting hole 1200 so that the items to be dehydrated moving through the sorting guide unit does not pass the sorting hole.

In the structure, the discharge guide unit 600 is installed in the pipe 300 for supplying items to be dehydrated.

The discharge guide unit 600 serves to move toward the discharge hole by lifting the items to be dehydrated upward during the dehydration process, and has only a simple screw wing form unlike the supply guide unit, and is formed in a spirally protruding structure in a vertical direction on the circumferential surface of the pipe 300 for supplying items to be dehydrated.

That is, in the discharge guide unit 600, the pipe 300 for supplying items to be dehydrated serves as the driving source, and in this case, spiral directions of the discharge guide unit 600 and the supply guide unit 500 are opposite to each other.

### Mode for Carrying Out the Invention

Hereinafter, functions of the present invention by the configuration and specific effects generated during the process will be described.

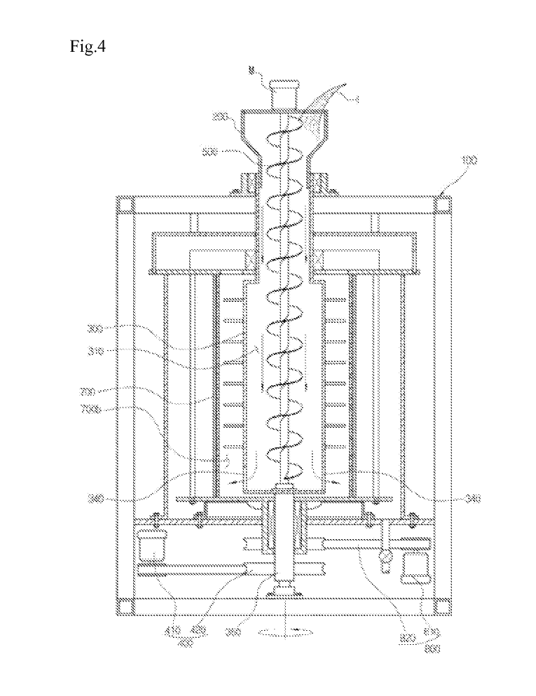

First, like FIG. 4, after the external items 1 to be dehydrated are supplied to the insertion hopper 200 and then received in the supply space 310 of the pipe 300 for supplying items to be dehydrated, and in this process, as the supply guide unit 500 rotates, the items 1 to be dehydrated in the insertion hopper 200 forcibly descend downward.

In addition, the items 1 to be dehydrated descending up to the lower end of the pipe 300 for supplying items to be dehydrated are discharged to the dehydration space 700a through the outlet hole 340.

In this process, the pipe 300 for supplying items to be dehydrated is rotated by the first driving motor 410, and as a result, as the discharge guide unit 600 is rotated together, the items to be dehydrated in the dehydration space rise upward by the rotation of the discharge guide unit.

In this process, since the dehydration tub 700 is rotated by the second driving unit 800, while the items to be dehydrated are lifted, the items to be dehydrated are lifted by centrifugal force acted by the rotation of the dehydration tub in a contact with the inner wall of the dehydration tub.

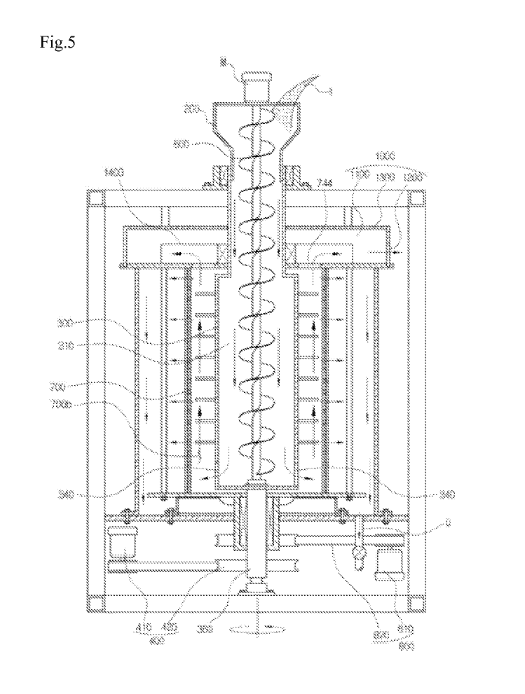

In this process, like FIG. 5, the water of the items to be dehydrated is discharged to the drain space through the dehydration hole of the dehydration tub and then flows into the drain pipe through drain gap to be discharged to the outside.

In this case, the water discharged from the dehydration tub moves along the inner wall of the case unit by the centrifugal force like FIG. 4 and then is discharged to the drain pipe, and in this process, the water collected on the partition 112 does not move toward the second driving shaft by the drain guide piece 900.

In addition, the items to be dehydrated which have the dehydrated solid form continuously ascend, and then flow into the sorting space 1100 of the sorting case 1300 through the discharge hole and move by the rotation force of the sorting guide unit 1400 to be discharged to the outside through the sorting hole 1200.

While the items to be dehydrated rise and are dehydrated and discharged in the dehydration tub, new items to be dehydrated are supplied to the pipe for supplying items to be dehydrated and supplied into the dehydration tub from the pipe for supplying items to be dehydrated by an amount of the internal items to be dehydrated are discharged to the outside, and then the above process is continuously repeated.

That is, during the dehydration and discharging process, as the new items to be dehydrated are continuously supplied, there is an advantage of having much more dehydration amount under the same scale and dehydration time as the related art.

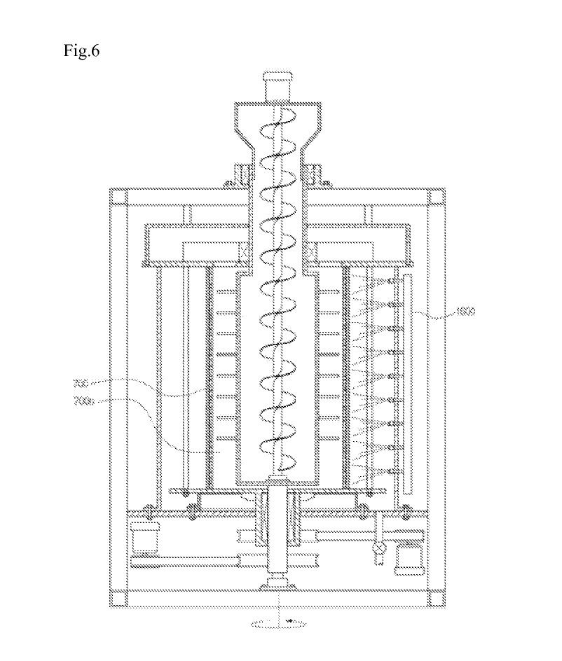

FIG. 6 is a diagram illustrating a modified example of the present invention, and basic constituent elements are same as the structure described above, but there is a difference in a configuration to clean foreign substances stained on the dehydration hole of the dehydration tub 700 through cleaning water discharged through a cleaning pipe 1600 by forming a separate cleaning pipe 1600.

In this case, in a state where a spray nozzle of the dehydration pipe is installed only at one side of the case unit, when cleaning is performed in a process of rotating the dehydration tub, the cleaning of the entire circumferential surface of the dehydration tub may be performed.

Accordingly, it is possible to prevent dehydration efficiency from deteriorating by removing the foreign substances of the dehydration hole.

Many features of the present invention described above may be performed by various modifications and combinations by those skilled in the art, but the modifications and the combinations have a multi-pipe form of the pipe for supplying items to be dehydrated and the dehydration tub. In addition, the modifications and the combinations are related with the configurations and the objects so that the dehydration is performed to obtain more dehydration amount even in the same scale as the related art, while the items to be dehydrated move from the lower end to the upper end of the dehydration tub after moving from the upper end to the lower end of the pipe for supplying items to be dehydrated, the modifications and the combinations should be determined to belong to the scope of the present invention.

1. A dehydrator, comprising: a main body having an installation space therein; a pipe for supplying items to be dehydrated, which is located within the installation space of the main body, one side of which has an inlet hole for items to be dehydrated that is connected to the outside, inside which a supply space connected to the inlet hole for items to be dehydrated is disposed, and the other side of which has an outlet hole connected to the supply space; a dehydration tub, which is rotatably arranged, which surrounds the pipe for supplying items to be dehydrated in the installation space, inside which a dehydration space connected to the outlet hole is arranged, the circumferential surface of which has a dehydration hole for interconnecting the dehydration space and the installation space, and one side of which has a discharge port for connecting the dehydration space to the outside; a first driving unit connected to the dehydration tub so as to rotate the dehydration tub; and a discharge guide unit located within the dehydration space so as to move the item to be dehydrated placed in the dehydration space toward the discharge port.

2. The dehydrator of claim 1, further comprising: a second driving unit connected to the pipe for supplying items to be dehydrated to rotate the pipe for supplying items to be dehydrated, wherein the discharge guide unit have a screw wing form to have a protruding form on the circumferential surface of the pipe for supplying items to be dehydrated along the length direction.

3. The dehydrator of claim 1, wherein the dehydration tub includes a first hydration pipe covering the pipe for supplying items to be dehydrated and a second dehydration pipe covering the first dehydration pipe.

4. The dehydrator of claim 1, further comprising: a supply guide unit positioned in the supply space and moving the items to be dehydrated inserted through the inlet hole toward the outlet hole.

5. The dehydrator of claim 1, further comprising: a sorting case positioned at one side of the dehydration tub, having a discharge space connected with the discharge port, and having a sorting hole connecting the discharge space and the outside at one side; and a sorting guide unit rotatably installed in the discharge space and moving the items to be dehydrated discharged through the discharge hole toward the sorting hole.

6. The dehydrator of claim 5, wherein the pipe for supplying items to be dehydrated passes through the sorting space, the discharge hole is formed around a passing point of the pipe for supplying items to be dehydrated of the dehydration tub, and the sorting guide unit is radially installed toward the outside based on the pipe for supplying items to be dehydrated to have a rotary wing form.

7. The dehydrator of claim 3, further comprising a water discharge port formed at one side of the dehydration tub to connect the installation space and the outside.

8. The dehydrator of claim 2, wherein the dehydration tub includes a first hydration pipe covering the pipe for supplying items to be dehydrated and a second dehydration pipe covering the first dehydration pipe.

9. The dehydrator of claim 2, further comprising: a supply guide unit positioned in the supply space and moving the items to be dehydrated inserted through the inlet hole toward the outlet hole.

10. The dehydrator of claim 2, further comprising: a sorting case positioned at one side of the dehydration tub, having a discharge space connected with the discharge port, and having a sorting hole connecting the discharge space and the outside at one side; and a sorting guide unit rotatably installed in the discharge space and moving the items to be dehydrated discharged through the discharge hole toward the sorting hole.
